(19) United States
(12) Patent Application Publication
(10) Pub. No.: US 2008/0057811 A1
(43) Pub. Date: Mar. 6, 2008

(54) Multifunctional hydrogel-web composites for enhanced absorbency applications and methods of making the same

(75) Inventors: Ali Yahiaoui, Roswell, GA (US); Anthony S. Spencer, Woodstock, GA (US); Charles E. Bolian, Buford, GA (US); Ann L. McCormack, Cumming, GA (US); Patrick L. Payne, Lithonia, GA (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/513,831

(22) Filed: Aug. 31, 2006

(51) Int. Cl. B32B 5/02

(52) U.S. Cl. 442/154; 442/79

(57) ABSTRACT

The present disclosure is generally directed to hydrogel-fibrous web composites that can be used in a variety of applications. For instance, the hydrogel-fibrous web composite can be used in the same applications as the base fibrous web, without the addition of the hydrogel, when it is desired to increase the moisture or water absorbency of the web. The hydrogel polymer is integral to the fibers of the web. Thus, the hydrogel allows the web to absorb water or moisture (including water vapor) to a much greater extend than the web alone. The present disclosure is also generally directed to methods of integrating a hydrogel polymer into a fibrous web.

### BACKGROUND

Fabrics, including both woven webs and nonwoven webs, and their manufacture have been the subject of extensive development resulting in a wide variety of materials for numerous applications. There have also been developed different ways and equipments to make fibrous webs having desired structures and compositions suitable for these uses. However, it is not always possible to efficiently produce a fibrous web having all the desired properties as formed, and it is frequently necessary to treat the fibrous web to improve or alter one or more properties. For instance, many fibrous webs have a limited ability to absorb water or water vapor.

Hydrogel polymers are known for their ability to absorb a large amount of water with respect to the weight of the hydrogel polymer. As such, hydrogels have been used, in particle form, in disposable absorbent articles, such as diapers, as a component of the absorbent core. In disposable absorbent product applications, dried hydrogel particles (sometimes referred to generically as superabsorbent particles) are generally mixed with other particles or fibers (e.g., pulp fibers) and formed into a fibrous web to form an absorbent core composite. The hydrogel particles are simply mixed with these fibers, but are not integral to the fibers of the web.

However, the use of hydrogel polymers in other applications, including with fibrous webs, has been limited due to the inability of the hydrogel polymer to be integrated with a carrier fibrous web. For example, when combined with fibers in forming a web, hydrogel polymer particles do not substantially interact, either chemically or physically, with the fibers. Thus, no substantial force exists to keep the particles within the web.

As such, a need currently exists to integrate a hydrogel polymer into a fibrous web. A need also exists to substantially increase the web's ability to absorb water, especially to substantially hydrophobic webs.

### SUMMARY

In accordance with one embodiment, a method for integrating a hydrogel polymer into a fibrous web is generally provided. The method includes applying a hydrogel precursor formulation to a fibrous web and polymerizing the hydrogel monomer. The hydrogel precursor formulation includes a hydrogel monomer, a crosslinker, and, depending on the energy source of polymerization, an initiator. Polymerization of the hydrogel monomer forms a hydrogel polymer having a three-dimensional crosslinked structure that is integral to the fibrous web.

The hydrogel monomers can include N-vinyl pyrrolidone, hydroxyethyl methacrylate, methacrylic acid or its salt, styrene sulfonic acid or its salt, potassium sulfopropyl acrylate, dimethyl acrylamide, dimethyl amino ethyl methacrylate or its quaternary salt derivative, or acrylamido methyl propane sulfonic acid or its salt. The initiator can be a photo-initiator, such that polymerization of the hydrogel monomer is initiated by UV light. The crosslinker can be methylene-bis-acrylamide, diethylene glycol diacrylate, poly(ethylene glycol) diacrylate, triethylene glycol-bis-methacrylate, ethylene glycol-bis-methacrylate, ethylene glycol-dimethacrylate, bisacrylamide, triethyleneglycol-bis-acrylate, 3,3′-ethylidene-bis(N-vinyl-2-pyrrolidone), trimethylolpropate trimethacrylate, glycerol trimethacrylate, polyethylene glycol dimethacrylate, or polymethacrylate crosslinkers. In some embodiments, the hydrogel precursor solution comprises a solublizer, a surfactant or other ingredients.

In another embodiment, the present invention is generally directed to a hydrogel-fibrous web composite comprising a web of fibers and a hydrogel polymer integrated within the fibers of the web. The hydrogel polymer has a three-dimensional crosslinked structure that is intertwined with the fibers of the web.

The hydrogel-fibrous web composite can be included in a variety of end products, such as garments (including, but not limited to, shirts, pants, gloves, socks, brassieres, hats, wristbands, boxer shorts, and jackets), packaging material, moisture control webs for confined spaces, and facemasks, to name a few.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is an exemplary embodiment of a process for impregnating a hydrogel monomer precursor formulation into a fibrous web;

FIG. 2 is an exemplary schematic of an embodiment of a process for producing a hydrogel-fibrous web composite;

FIGS. 3A-3D are exemplary embodiments of a t-shirt constructed, at least in part, from a hydrogel-fibrous web composite;

FIG. 4 is an exemplary embodiment of a jacket including an inner liner constructed of a hydrogel-fibrous web composite;

FIG. 5 is an exemplary embodiment of an insert constructed of a hydrogel-fibrous web composite for a shoe;

FIG. 6 is an exemplary embodiment of a glove constructed, at least in part, of a hydrogel-fibrous web composite;

FIG. 7 is an exemplary embodiment of a face mask constructed, at least in part, of a hydrogel-fibrous web composite;

FIG. 8 is an exemplary embodiment of a wrist band constructed, at least in part, of a hydrogel-fibrous web composite;

FIG. 9 is an exemplary embodiment of a hat constructed, at least in part, of a hydrogel-fibrous web composite; and

FIG. 10 is an exemplary embodiment of a brassier, at least in part, of a hydrogel-fibrous web composite.

Repeat use of references characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claims and their equivalents.

### DEFINITIONS

As used herein, the term “hydrogel” refers to a polymeric material that is capable of absorbing more than 20% its weight in water while maintaining a distinct three-dimensional structure. Additionally, the term “hydrogel monomer” may refer to the polymerizing formulation or hydrogel precursor (including the hydrogel monomer) which is converted to a hydrogel when polymerization is triggered via conventional processes such as UV radiation (or UV curing), gamma rays, electron-beam, heat, chemical initiation, etc., as discussed elsewhere herein.

As used herein, the term “fibrous web” includes any web having a structure of individual threads (e.g., fibers or filaments), including woven webs, nonwoven webs, scrim, knitted webs, etc.

As used herein, the term “nonwoven web” refers to a web having a structure of individual threads (e.g., fibers or filaments) that are randomly interlaid, not in an identifiable manner as in a knitted fabric. Nonwoven webs include, for example, meltblown webs, spunbond webs, carded webs, wet-laid webs, airlaid webs, coform webs, hydraulically entangled webs, etc. The basis weight of the nonwoven web may generally vary, but is typically from about 5 grams per square meter (“gsm”) to 200 gsm, in some embodiments from about 10 gsm to about 150 gsm, and in some embodiments, from about 15 gsm to about 100 gsm.

As used herein, the term “meltblown web” generally refers to a nonwoven web that is formed by a process in which a molten thermoplastic material is extruded through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that are substantially continuous or discontinuous, generally smaller than 10 micrometers in diameter, and generally tacky when deposited onto a collecting surface.

As used herein, the term “spunbond web” generally refers to a web containing small diameter substantially continuous filaments. The filaments are formed by extruding a molten thermoplastic material from a plurality of fine, usually circular, capillaries of a spinnerette with the diameter of the extruded filaments then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. The filaments may, for example, have a length much greater than their diameter, such as a length to diameter ratio (“aspect ratio”) greater than about 15,000 to 1, and in some cases, greater than about 50,000 to 1. The filaments may sometimes have diameters less than about 40 micrometers, and are often between about 5 to about 20 micrometers.

As used herein “carded webs” refers to nonwoven webs formed by carding processes as are known to those skilled in the art and further described, for example, in coassigned U.S. Pat. No. 4,488,928 to Alikhan and Schmidt which is incorporated herein in its entirety by reference. Briefly, carding processes involve starting with staple fibers in a bulky batt that is combed or otherwise treated to provide a generally uniform basis weight. A carded web may then be bonded by conventional means as are known in the art such as for example through air bonding, ultrasonic bonding and thermal point bonding.

As used herein, an “airlaid” web is a fibrous web structure formed primarily by a process involving deposition of loose, air-entrained fibers onto a porous or foraminous forming surface. Generally, the web includes cellulosic fibers such as those from fluff pulp that have been separated from a mat of fibers, such as by a hammermilling process, and then entrained in a moving stream of air and deposited or collected on the forming screen or other foraminous forming surface, usually with the assistance of a vacuum supply, in order to form a dry-laid fiber web. There may also be other fibers such as thermoplastic staple fibers or binder fibers present, and typically following collection of the fibers on the forming surface the web is densified and/or bonded by such means as thermal bonding or adhesive bonding. In addition, super absorbent materials in particulate or fiber form may be included in airlaid webs where desired. Equipment for producing air-laid webs includes the Rando-Weber air-former machine available from Rando Corporation of New York and the Dan-Web rotary screen air-former machine available from Dan-Web Forming of Risskov, Denmark.

### DETAILED DESCRIPTION

Generally speaking, the present invention is directed to hydrogel-fibrous web composites that can be used in a variety of applications. For instance, the hydrogel-fibrous web composite can be used in the same applications as the base fibrous web, without the addition of the hydrogel, when it is desired to increase the moisture or water absorbency of the web. In fact, the present inventors have surprisingly found that the integration of the hydrogel polymer within the fibrous webs does not substantially alter or affect the other chemical and physical properties or characteristics of the web. In addition, the web can act as a scaffold or support matrix that enhances mechanical properties of the hydrogel, especially under wet conditions. Also, the web can provide a fiber structure, pore size, and pore distribution to achieve a tailored handling of aqueous fluids. For example, a meltblown web, which has relatively small pore size, is useful for wicking away and distributing an aqueous fluid over a large area, while a bonded carded web is useful for applications when high fluid holding capacity is desired. Fluid handling capacity can be controlled by the relative hydrogel content in the hydrogel-fibrous web composite.

According to the present invention, the hydrogel polymer is integral to the fibers of the web. For example, the hydrogel polymer can be intertwined with the fibers of the webs. As such, the hydrogel polymer cannot be easily separated from the web and is effectively a permanent part of the structure of the web. Thus, the hydrogel allows the web to absorb water or moisture (including water vapor) to a much greater extend than the web alone. For instance, in one embodiment, the hydrogel polymer can be integrated into a hydrophobic fibrous web that would not otherwise absorb any substantial amount of water or moisture, changing a relatively hydrophobic web to be water and moisture absorbent.

In some embodiments, the hydrogel extends through the thickness of the web. For example, the hydrogel may extend beyond the thickness of the web. As such, the thickness of the web will be smaller than the thickness of the hydrogel. Without wishing to be bound by theory, it is believed that the moisture absorption ability of the hydrogel-fibrous web composite can be enhanced by having the hydrogel extend beyond the thickness of the web, such that the exposed outer layer of the composite is primarily the hydrogel.

In order to integrate the hydrogel polymer into the fibrous web, the hydrogel polymer is polymerized from monomers that have been saturated and impregnated within the fibrous web. Upon polymerization, the resulting hydrogel polymer forms within the fibrous web, effectively integrating the hydrogel polymer within the fibers of the web. For instance, the hydrogel polymer can be intertwined with the fibers of the web. Also, the hydrogel polymer typically crosslinks with itself to form a three-dimensional polymer network that is integral to and intertwined with the fibers of the web. As such, the hydrogel polymer network is physically integrated within the web and cannot be easily separated from the fibers of the web.

In some embodiments, depending upon the nature of the fibers of the web, the type of hydrogel polymer used, and the energy source used to initiate polymerization, the hydrogel polymer can also have additional chemical bonds or forces further attracting the hydrogel to the fibers of the web. For instance, the hydrogel polymer may crosslink with the fibers of the web, forming covalent bonds with the fibers of the web. In other embodiments, other chemical forces, such as van-der-Waals forces, hydrogen bonding, ionic bonding, etc., further attracting integrate the hydrogel polymer to the fibers of the web.

During the manufacture of the hydrogel-fibrous web composite, a hydrogel precursor is provided in a solution form, allowing the hydrogel precursor formulation to saturate the fibrous web. In one embodiment, the hydrogel precursor formulation contains the hydrogel-forming monomer(s), a crosslinker, and any other optional ingredients desired.

In general, any of a variety of hydrogel monomers may be utilized to form the hydrogel polymer integral to the fibers of the web. While any suitable monomer is contemplated, exemplary functional monomers include: N-vinyl pyrrolidone (NVP), hydroxyethyl methacrylate (HEMA), methacrylic acid (MA) or its salt, styrene sulfonic acid (SSA) or its salt, potassium sulfopropyl acrylate (KPSA), dimethyl acrylamide (DMA), dimethyl amino ethyl methacrylate (DMAEMA) or its quaternary salt derivative, acrylamido methyl propane sulfonic acid (AMPS) or its salt, and the combination of any of the above. Desirably, the hydrogels of the present invention are made from various classes of monomers including acrylates, vinyls, amides, esters, etc, of which can be electrically neutral, cationic or anionic. Combination of functional monomers also is possible to achieve desired physical, chemical, and mechanical properties.

In one particular embodiment, 2-acrylamido-2-methyl propane sulfonic acid (AMPS), or its salt, can be used as the hydrogel monomer, either alone or in combination with another comonomer. Generally, AMPS is highly hydrophilic, is easy to work with, and polymerizes relatively easily. Also, AMPS, as a monomer, has a relatively favorable safety profile. As such, AMPS or its salt may be suitable for large scale production of a hydrogel monomer precursor solution.

Generally, the hydrogel precursor includes between about 5 to about 80% by weight of the monomer, more desirably between about 20 to about 75% by weight of the monomer, and even more desirably between about 30 to about 75% by weight of the monomer.

The hydrogel monomer can also be combined with at least one co-monomer to form the hydrogel polymer. Examples of co-monomers which may be used include co-monomers soluble in water and, even more desirably, include anionic co-monomers. The amount of co-monomer to be used may be in the range of about 5 to about 50% by weight, desirably about 10 to about 30% by weight, based on the amount of reactants used. Examples of suitable co-monomers include, but are not limited to: unsaturated organic carboxylic acids such as acrylic acid, methacrylic acid, maleic acid, itaconic acid, and citraconic acid and salts thereof, unsaturated organic sulfonic acids such as styrene sulfonic acid, methallyl sulfonic acid, 2-sulfoethyl acrylate, 2-sulfoethyl methacrylate, 3-sulfopropyl acrylate, 3-sulfopropyl methacrylate, acrylamido-methylpropane sulfonic acid and salts thereof, N,N-dimethylacrylamide, vinyl acetate, other radically polymerizable ionic monomers containing a carbon-carbon double bond, and non-N-vinyl lactam co-monomers useful with N-vinyl lactam monomeric units such as N-vinyl-2-pyrrolidone, N-vinyl-2-valerolactam, N-vinyl-2-caprolactam, and mixtures thereof. Among the ionic monomers enumerated above, particularly desirable selections are 2-acrylamido-2-methyl propane sulfonic acid and salts thereof. Examples of cations involved in the formation of such salts include sodium, potassium, lithium, and ammonium ions. Ionic monomers may be used alone or in a mixture of two or more monomers.

In some embodiments, an initiator is present in the hydrogel precursor formulation. The initiators can be photo-initiators, thermal-initiators, or chemical initiators. For example, in one particular embodiment, a UV-initiator can be included in the hydrogel precursor. Chemical initiators can also be used, such as redox, peroxide, etc. In other embodiments, other radiation initiation processes, such as gamma rays, e-beam, X-ray, etc., can be utilized, which may not require the presence of an initiator in the hydrogel precursor formulation.

For example, a non-limiting list of UV-initiators which may be used include IRGACURE® 184 (1-hydroxycyclohexyl phenyl ketone), IRGACURE® 2959 (4-(2-hydroxyethoxy)phenyl-(2-hydroxy-2-methylpropyl)ketone)), and DAROCURE® 1173 α-hydroxy-α,α-dimethylacetophenone), all commercially available from Ciba Specialty Chemicals (Terrytown, N.Y.). These UV initiators are particularly useful because they are non-yellowing, i.e., they can maintain a desired water-white and/or water-clear appearance of the hydrogels.

Other initiators which may maintain the desired water-white and water-clear appearance of the present hydrogels also are desired. Additional examples of suitable initiators (which may be photo-initiators or thermally activated initiators) may include benzoyl peroxide, azo-bis-isobutyro-nitrile, di-t-butyl peroxide, bromyl peroxide, cumyl peroxide, lauroyl peroxide, isopropyl percarbonate, methylethyl ketone peroxide, cyclohexane peroxide, tutylhydroperoxide, di-t-amyl peroxide, dicumyl peroxide, t-butyl perbenzoate, benzoin alkyl ethers (such as benzoin, benzoin isopropyl ether, and benzoin isobutyl ether), benzophenones (such as benzophenone and methyl-o-benzoyl benzoate), actophenones (such as acetophenone, trichloroacetophenone, 2,2-diethoxyacetophenone, p-t-butyltrichloro-acetophenone, 2,2-dimethoxy-2-phenyl-acetophenone, and p-dimethylaminoacetophenone), thioxanthones (such as xanthone, thioxanthone, 2-chlorothioxanthone, and 2-isopropylthioxanthone), benzyl 2-ethyl anthraquinone, methylbenzoyl formate, 2-hydroxy-2-methyl-1-phenylpropane-1-one, 2-hydroxy-4′-isopropyl-2-methyl propiophenone, α-hydroxy ketone, tetramethyl thiuram monosulfide, allyl diazonium salt, and combinations of camphorquinone and ethyl 4-(N,N-dimethylamino)benzoate. Other suitable initiators may be found in, for example, Berner, et al., “Photo-initiators—An Overview”, J. Radiation Curing (April 1979), pp. 2 9.

When present, only one initiator is necessary, however, the hydrogel precursor formulation may contain one or more second initiators. The one or more second initiators can be photo or chemical initiators.

Where there is only one initiator, the amount of initiator is desirably within the range of about 0.01 to about 5% by weight of the hydrogel precursor, more desirably, within the range of about 0.05 to about 2% by weight of the hydrogel precursor and, even more desirably, within the range of about 0.1 to about 0.5% by weight of the hydrogel precursor. Where one or more second initiators are present, the amount of one or more second initiators is desirably within the range of about 0.01 to about 5% by weight of the hydrogel precursor, and more desirably within the range of about 0.05 to about 2% by weight of the hydrogel precursor and, even more desirably, within the range of about 0.1 to about 0.5% by weight of the hydrogel precursor. However, where multiple initiators are present, it is generally desirable that the combined amount of the initiators be about 5% or less by weight of the hydrogel precursor, and more desirably within the range of about 0.02 to about 5% by weight of the hydrogel precursor.

In one embodiment, the hydrogel polymer may be formed from at least one hydrogel-forming monomer by free radical polymerization in the presence of water, initiated by ultra-violet radiations (or UV curing) with a photo-initiator and a multifunctional cross-linking agent. UV curing parameters to achieve desired polymer properties are well known to those skilled in the art. A photo-initiator for the present purposes tends to operate by absorbing select wavelengths of UV to produce radical initiating species to induce monomer polymerization. The wavelengths and curing area set the style of UV bulb used in the curing process. Inhibition of polymerization due to dissolved oxygen, monomer inhibitors, or other radical scavenging moieties may be overcome by changing the power, by pulsing, and/or by using initiator accelerators.

It will be appreciated that each photo-initiator is responsive to a specific or narrow wavelength range of UV light. At least one aspect takes advantage of this property and incorporates two or more photo-initiators in a hydrogel precursor. The addition of more than one initiator in a hydrogel precursor allows for a broader range of the energy or range of wavelengths emitted by a UV source to be utilized. The utilization of multiple initiators can further reduce solubility limit concerns and related compatibility concerns, as more efficient polymerization may be able to be achieved with two initiators present in a hydrogel precursor than with either of the initiators used alone at the same overall initiator concentration. Multiple initiators may also maximize the use of the full UV spectrum available.

As is also noted above, cross-linking agents may be desirably present in the hydrogel precursor to cross-link the hydrogel polymers formed from the precursor solution of monomers. Examples of multi-functional cross-linking agents which may be used include, for example, methylene-bis-acrylamide and diethylene glycol diacrylate which are both commercially available from Polysciences, Inc., Warrington, Pa. Additional examples of cross-linking agents include, but are not limited to: poly(ethylene glycol) diacrylate, triethylene glycol-bis-methacrylate, ethylene glycol-bis-methacrylate, ethylene glycol-dimethacrylate, bisacrylamide, triethyleneglycol-bis-acrylate, 3,3′-ethylidene-bis(N-vinyl-2-pyrrolidone), trimethylolpropate trimethacrylate, glycerol trimethacrylate, polyethylene glycol dimethacrylate, and other multifunctional polyacrylate and polymethacrylate crosslinkers.

The amount of cross-linking agent is desirably within the range of about 0.01 to about 2% by weight of the hydrogel precursor and, more desirably, within the range of about 0.05 to about 0.5% by weight of the hydrogel precursor.

Regardless of the technique utilized, crosslinking forms a hydrogel constituted by a three-dimensional network that is substantially water-insoluble. Thus, when exposed to water, the hydrogel does not dissolve, but instead may absorb a certain amount of water. For example, the hydrogel is capable of achieving a water content of at least about 20%, such as from about 20% to about 90%, in some embodiments from about 35% to about 85%, and in some embodiments, from about 50% to about 80%. Thus, the hydrogel-fibrous web composite is capable of absorbing perspiration from the skin of a wearer of a garment constructed, at least in part, of the hydrogel-fibrous web composite. The water content of the hydrogel is determined as follows:

% water content=100×(W_{w}−W_{d})/W_{w}

wherein W_{w} is the weight of the wet hydrogel and W_{d} is the weight of dry hydrogel.

Upon absorbing water, the hydrogel swells, thereby increasing the area between crosslinks to form pores. For example, at its highest water content, the hydrogel may possess pores having an average size of from about 1 nanometer to about 10 microns, in some embodiments from about 10 nanometers to about 1 micron, and in some embodiments, from about 50 nanometers to about 100 nanometers.

In most embodiments, water is the solvent used for the hydrogel precursor formulation, although other suitable solvents can be used. Additionally, the precursor solution can also include a solubilizer to enhance the polymerization of the monomer, crosslinker, and/or initiator, such as described in U.S. Pat. No. 7,045,559, which is incorporated herein in its entirety. Any suitable solubilizer or combination of solubilizers is contemplated. The desirability of a specific solubilizer and/or the amount thereof which is included in hydrogel precursor may vary or depend in part on the other components and quantities thereof selected to make up the hydrogel precursor. Exemplary solubilizers include but are not limited to cyclodextrin, cyclodextrin derivatives, and hydrotropes. Specific exemplary cyclodextrin derivative solubilizers that are known to work in at least one aspect of the present invention include hydroxypropyl beta-cyclodextrin (HP-β-CD) (available from Cargill Dow, Minnetonka, Minn.), gamma cyclodextrin (gamma-CD) (available from Wacker Biochem Corporation, Adrian, Mich.) and other polymerizable cyclodextrin derivatives such as methacryloyl cyclodextrin. In a particular embodiment, the solubilizer is dimethyl sulfoxide (DMSO). In another particular embodiment, the solubilizer is glycerin.

If a specific initiator is selected, then some solubilizers may be more desirable than others. That being said, it is contemplated that a solubilizer may be present in a positive amount up to about 20% by weight of the hydrogel precursor and, more desirably, between about 0.5% to about 5% by weight of the hydrogel precursor.

While the use of solubilizers is contemplated so as to alleviate solubility concerns, it is also believed that the inclusion of multiple initiators which may be present at levels which independently would have been insufficient to obtain the desired polymerization can enable the use of additional initiators whose solubility limits in hydrogel precursors effectively precluded their use previously. It is further believed that the inclusion of initiators having different rates of initiation and/or the inclusion of initiators which begin initiation of polymerization of the monomer at different times relative to each other (such as that which may be experienced by multiple initiators (e.g., a thermally activated chemical initiator (TACI) and a photo-initiator) contributes to a higher yield of polymerization. That is, for example, where two photo-initiators are included, one may have a lower UV wavelength trigger and may be more energetic (providing for a faster rate of initiation and reaction) than the other initiator which is triggered by a higher UV wavelength or range. The faster initiator may also die or be consumed faster than the other. It is contemplated that it may be advantageous to have polymerization occur at different rates and/or at a mixed rate which may not be obtainable with one initiator or with an initiator which is suitable for a particular hydrogel precursor. An example of initiators which are not triggered or activated simultaneously, may be found where a photo-initiator and a TACI are in a hydrogel precursor, and the photo-initiator is triggered by a UV source and reacts with the monomers in the precursor so as to generate heat to trigger the TACI.

While numerous combinations and variations of initiators are possible, it is believed that the combination of multiple initiators provides more favorable kinetics which afford a higher probability of more extensive polymerization of the monomer and/or other monomeric residues. Of course, if desired or necessary, the multiple initiators also could be present at elevated solubility levels. In either instance, the inclusion of multiple initiators can result in a more completely polymerized hydrogel.

A TACI may be included to take advantage of the benefits of multiple initiator polymerization. As some heat is necessary to trigger a TACI, it is contemplated that a TACI will generally be included only where heat will be present in or produced in the hydrogel precursor in a sufficient amount to trigger the TACI. As radical polymerization reactions induced by photo-initiators are known to be exothermic and thus to generate heat in response to UV exposure, at least one aspect is directed to the inclusion of a TACI in a hydrogel precursor where a photo-initiator is also present so as to allow the TACI to take advantage of the heat generated by the radical polymerization reaction induced by a photo-initiator. It is also contemplated that a TACI can be included where multiple photo-initiators are present. The presence of multiple photo-initiators provides for the potential benefits of multiple initiators discussed above yet also provides for the triggering of a TACI where the heat generated by one photo-initiator may be insufficient to trigger or fully trigger the TACI (depending on the photo-initiators and the TACI involved), whereby the TACI can further promote or complete the polymerization of the functional monomer and other monomeric residues in a hydrogel precursor. Multiple TACIs are also contemplated.

The hydrogels may include a buffer system to help control the pH, prevent discoloration, and/or prevent breakdown due to an extended presence of water (i.e., hydrolysis). The use of a buffer system with the present hydrogel is desired to provide the hydrogel with a commercially suitable shelf-life (i.e., a shelf-life of over one year) without discoloration. Suitable buffers include but are not limited to sodium potassium tartarate, and/or sodium phosphate monobasic, both of which are commercially readily available from Aldrich Chemical Co., Inc., Milwaukee, Wis.

In some embodiments, at least one surfactant can be included in the hydrogel precursor solution or added to the hydrogel-fibrous web composite. It is believed that the presence of a surfactant can increase the rate of absorbency of water and moisture of the hydrogel. Exemplary surfactant include, but are not limited to, alkyl polyglycosides; silicones modified to contain alkyl, polyglycol, and/or amino groups (e.g., ethyoxylated polydimethyl siloxanes); alkylphenol ethoxylate surfactant; and the like. Commercially available examples of suitable alkyl polyglycosides include Glucopon 220, 225, 425, 600 and 625, all available from Cognis Corporation. These products are all mixtures of alkyl mono- and oligoglucopyranosides with alkyl groups based on fatty alcohols derived from coconut and/or palm kernel oil. Glucopon 220, 225 and 425 are examples of particularly suitable alkyl polyglycosides. Glucopon 220 is an alkyl polyglycoside which contains an average of 1.4 glucosyl residues per molecule and a mixture of 8 and 10 carbon alkyl groups (average carbons per alkyl chain-9.1). Glucopon 225 is a related alkyl polyglycoside with linear alkyl groups having 8 or 10 carbon atoms (average alkyl chain-9.1 carbon atoms) in the alkyl chain. Glucopon 425 includes a mixture of alkyl polyglycosides which individually include an alkyl group with 8, 10, 12, 14 or 16 carbon atoms (average alkyl chain-10.3 carbon atoms). Glucopon 600 includes a mixture of alkyl polyglycosides which individually include an alkyl group with 12, 14 or 16 carbon atoms (average alkyl chain 12.8 carbon atoms). Glucopon 625 includes a mixture of alkyl polyglycosides which individually include an alkyl group having 12, 14 or 18 carbon atoms (average alkyl chain 12.8 carbon atoms). Another example of a suitable commercially available alkyl polyglycoside is TL 2141, a Glucopon 220 analog available from ICI. BASF Corporation offers MASIL® silicones that are modified to contain alkyl, polyglycol, amino groups, which may be included in the hydrogel precursor formulation. For instance, MASIL® SF-19 is a modified silicone glycol.

The amount of hydrogel integrated into the fibrous web can be controlled by the amount of hydrogel monomer present in the precursor solution. As such, controlling the amount of hydrogel in the composite web allows for control of the amount of water or moisture that can be absorbed by the composite web. Depending on the intended use of the hydrogel-fibrous web composite, the hydrogel can be present in the hydrogel-fibrous web composite at relatively high add-on levels, such as greater than about 1000 wt %, such as greater than about 1200 wt. %, such as from about 1400 wt. % to about 3000 wt. %. For instance, the add-on level of the hydrogel to the fibrous web can be greater than about 1500 wt. %, such as greater than about 2000 wt. %. In other embodiments, the add-on levels of the hydrogel can be from about 500 wt. % to about 2000 wt. %. In other embodiments, the add-on levels of the hydrogel to the fibrous web can be lower, such as from about 200 wt. % to about 1000 wt. %, or less than 200 wt. %.

Expressed in terms of basis weight, the hydrogel can be present in the hydrogel-fibrous web composite at basis weights of from about 10 gsm to about 100 gsm or even higher, from about 50 gsm to about 900 gsm, from about 100 gsm to about 800 gsm, from about 200 gsm to about 700 gsm, or from about 300 gsm to about 600 gsm, though higher or lower basis weights may be desired depending on the particular use.

Also, the location of the hydrogel integrated within the web can be somewhat controlled by the wettability and structure of the web and the manner of application of the hydrogel precursor formulation to the web. For instance, application of the hydrogel precursor formulation to only one side of the web, and subsequent polymerization, can result in the hydrogel polymer being present mainly in that side of the web. Viscosity modifiers can also be added to increase the viscosity of the hydrogel precursor formulation to allow for controlled placement and formation of the hydrogel following polymerization.

As one skilled in the art will recognize, any method of saturating and/or impregnating the hydrogel precursor formulation into the web may be used. For example, the hydrogel precursor formulation may be applied to the fibrous web using any conventional technique, such as bar, roll, knife, curtain, foam, print (e.g., rotogravure), slot-die, drop-coating, or dip-coating techniques. For instance, the hydrogel precursor formulation can be applied topically to the external surfaces of the fibrous web. In one particular embodiment, the hydrogel precursor formulation is applied uniformly to one or both surfaces of the fibrous web.

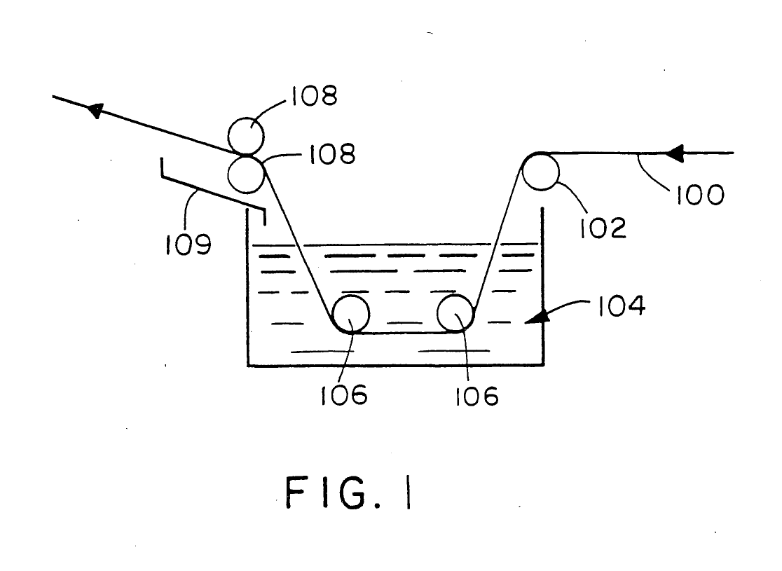

FIG. 1 illustrates an exemplary embodiment using a web saturation step. As shown, a fibrous web 100 passes over a guide roll 102 and into a bath 104 with the treatment time controlled by first and second guide rolls 106. The nip between first and second squeeze rolls 108 removes any excess hydrogel precursor formulation which is returned to the bath by a catch pan 109.

In other application techniques, where one desires to treat only a single side, and not the inner layers or opposing side of the fibrous web, other processes can be used, such as rotary screen, reverse roll, Meyer-rod, Gravure, slot-die, gap-coating, etc. However, even according to these application techniques, a sufficient amount of the hydrogel precursor formulation penetrates the web, allowing the hydrogel to be integral to the fibers upon polymerization.

No matter the method of impregnation or saturation of the web, the hydrogel monomers saturated and/or impregnated within the web may be polymerized, either before or after drying of the web, depending on the polymerization initiation method. For instance, when a UV-initiator is present in the hydrogel precursor formulation to initiate the polymerization of the hydrogel monomers upon the application of UV radiation, the web 100 can be passed under a UV lamp (not shown) for a specific time allowing for the desired degree of polymerization, prior to drying the web. Then, the web 100 can be further dried, if needed, by passing over dryer cans (not shown) or other drying means and then wound between two release film or paper layers as a roll or converted to the use for which it is intended. Alternative drying means include ovens, through air dryers, infra red dryers, air blowers, and the like.

Drying the hydrogel-fibrous web composite can control the water content of the composite, which can affect the amount of water that the hydrogel can absorb. In most applications, the water content of the hydrogel in the hydrogel-fibrous web composite will be relatively low, which allows for more water and moisture to be absorbed by the hydrogel. For example, the water content of the hydrogel in the hydrogel-fibrous web composite will be less than about 20 wt. %, such as less than about 15 wt. %. For instance, the water content of the hydrogel in the hydrogel-fibrous web composite will be less than about 10 wt. %, such as less than about 5 wt. %. In some particular embodiments, the water content can be less than about 2 wt. %.

For example, referring to the schematic shown in FIG. 2, the fibrous web 100 passes over a guide roll 110 from a fibrous web supply roll 112. First, the fibrous web 100 is impregnated or saturated with the hydrogel precursor formulation in treatment center 114. Then, the treated fibrous web 100 is combined with a first release layer 116 supplied from a release layer supply roll 118. The treated fibrous web 100 is then cured in a curing station 120, such as, for example, by UV radiation. The fibrous web 100 is then dried in a dryer 122, and combined with a second release layer 124 supplied from a release layer supply roll 126. Finally, the treated fibrous web 100 sandwiched between the first release layer 116 and the second release layer 124 can then be rewound on a roll 128.

It is also understood that the method of treatment of fibrous web with the impregnating hydrogel precursor formulation may also incorporate other ingredients into the web. For example, the hydrogel precursor formulation may include other additives, such as conductivity enhancers, pharmaceuticals, humectants, plasticizers, skin health agents, odor control agents, antioxidants, dyes, scent, preservatives, anti-microbial agents, anti-viral agents, and the like, within the fibrous web. These other additives may be included either before or after a curing step. For instance, in some embodiments, the additives may be present in the hydrogel precursor formulation, which can help the additive become impregnated within the resulting hydrogel-fibrous web composite. The appropriateness of such additives is generally dependent upon the intended end use of the particular hydrogel.

Any suitable additive or combination of additives such as those suggested above is contemplated. The specific additive and/or the amount thereof which is included may vary or depend in part on the other components and quantities thereof selected to make up the hydrogel. Exemplary skin health agents and/or skin care ingredients include but are not limited to vitamins (e.g., B, D, E, E acetate, etc.), antioxidants, chitosan, aloe Vera, hyaluronic acid (HA), heparin, chondroitin sulfate, dextran sulfate, glycerin, and collagen IV. Still other exemplary additives may include but are not limited to anti-inflammation agents, anti-oxidants, antimicrobial agents, aesthetic agents (e.g., color dyes to alter appearance of the hydrogels), or fragrances.

The hydrogel can be integrated into any suitable fibrous web, including both woven and nonwoven webs. In general, the intended end use of the composite web will dictate the composition and type of web utilized. In one particular embodiment, the fibrous web is a porous fibrous web. In this embodiment, the porosity of the fibrous web allows the hydrogel to penetrate the pores of the web and for greater fluid transport of water and moisture into the web, facilitating the ability of the integrated hydrogel to absorb the water and moisture. Also, in those applications where comfort and breathability is desired, the porous fibrous web can be breathable, allowing air to flow through the web, while moisture and water are retained within the web. In other embodiments, porous films and foams can also be used in similar fashion as porous webs.

For example, the nonwoven web may be a spunbond web, a meltblown web, a bonded carded web, or another type of nonwoven web, including natural and/or synthetic fibers, and may be present in a single layer or a multilayer composite including one or more nonwoven web layers.

When constructed of synthetic polymers, a wide variety of thermoplastic polymers may be used to construct the nonwoven substrate, including without limitation polyamides, polyesters, polyolefins, copolymers of ethylene and propylene, copolymers of ethylene or propylene with a C₄-C₂₀ alpha-olefin, terpolymers of ethylene with propylene and a C₄-C₂₀ alpha-olefin, ethylene vinyl acetate copolymers, propylene vinyl acetate copolymers, styrene-poly(ethylene-alpha-olefin) elastomers, polyurethanes, A-B block copolymers where A is formed of poly(vinyl arene) moieties such as polystyrene and B is an elastomeric midblock such as a conjugated diene or lower alkene, polyethers, polyether esters, polyacrylates, ethylene alkyl acrylates, polyisobutylene, polybutadiene, isobutylene-isoprene copolymers, and combinations of any of the foregoing. In some particular embodiments, polyolefins, such as polyethylene and polypropylene homopolymers and copolymers, can be used to construct the nonwoven web. The webs may also be constructed of bicomponent or biconstituent filaments or fibers. The nonwoven webs may have a wide variety of basis weights, preferably ranging from about 8 grams per square meter (gsm) to about 120 gsm.

Particularly suitable nonwoven webs can be hydrophobic webs, such as those including polyolefin fibers and polyester fibers. For example, meltblown and spunbond webs of polyolefin fibers, such as polypropylene and polyethylene, can be integrated with hydrogel polymers to change the otherwise hydrophobic web to a water absorbent web, without substantially affecting the other properties of the web.

The type of nonwoven web can dictate the function of the resulting composite hydrogel-fibrous web. For example, a meltblown web, which has relatively small pore size, is useful for wicking away and distributing an aqueous fluid over a large area, while a bonded carded web is useful for applications when high fluid holding capacity is desired. Fluid handling capacity can be controlled by the relative hydrogel content in the hydrogel-fibrous web composite.

In some embodiments, the nonwoven web can be a composite nonwoven web, including but not limited to, coform webs, webs entangled with pulp fibers, etc. For instance, a suitable nonwoven composite web can be a polypropylene web entangled with pulp fibers, such as the fabric sold under the name Hydroknit® by Kimberly-Clark Corp., Inc. of Neenah, Wisc.

In another embodiment, the web can be a woven web. For instance, certain applications will typically involve woven webs of cotton, polyester, nylon, wool, and the like, and combinations thereof. For example, in some clothing applications, the fibrous web can be a woven web.

Additionally, the hydrogel-fibrous web composite can be combined with other webs to form a laminate. For instance, the hydrogel-fibrous web composite can be one or more layers of an spunbond-meltblown-spunbond (SMS) web.

The fibrous webs integrated with a hydrogel can be used in any application of the base fibrous web where it is desirous to improve the water or moisture absorption of the fibrous web. Although many useful embodiments are particularly described in the following discussion and in the attached figures, one of ordinary skill in the art will appreciate that the use of the fibrous webs is not limited to these particular applications. As stated above, the composite hydrogel-fibrous webs described herein can be useful in any application where it is desirous to increase the fibrous web's ability to absorb water and moisture.

Composite hydrogel-fibrous webs can be utilized, for instance, in packaging for moisture sensitive products, such as some pharmaceuticals, other chemicals, food stuffs, etc. In another embodiment, composite hydrogel-fibrous webs can be used as drawer and shelf liners for clothing, household supplies and dishes, industrial warehouses, etc. Composite hydrogel-fibrous webs may also be configured for moisture control in confined spaces, such as basements, greenhouses, laboratories, bathrooms, clean rooms (e.g., in the manufacture of electronic devices) and the like.

For example, in garment applications, the hydrogel-fibrous web composite material can be used to produce an entire clothing article, or can be used to produce only a portion of a clothing article. For instance, the hydrogel-fibrous web composite can be utilized in a portion of the clothing article that commonly interacts with moisture when worn by a wearer. Specifically, the hydrogel-fibrous web composite material can be located in those areas more prone to contact areas of the body which are more apt to sweat. The inclusion of the hydrogel-fibrous web composite in these clothing applications can allow water and moisture to be absorbed by the clothing article, keeping the wearer dry.

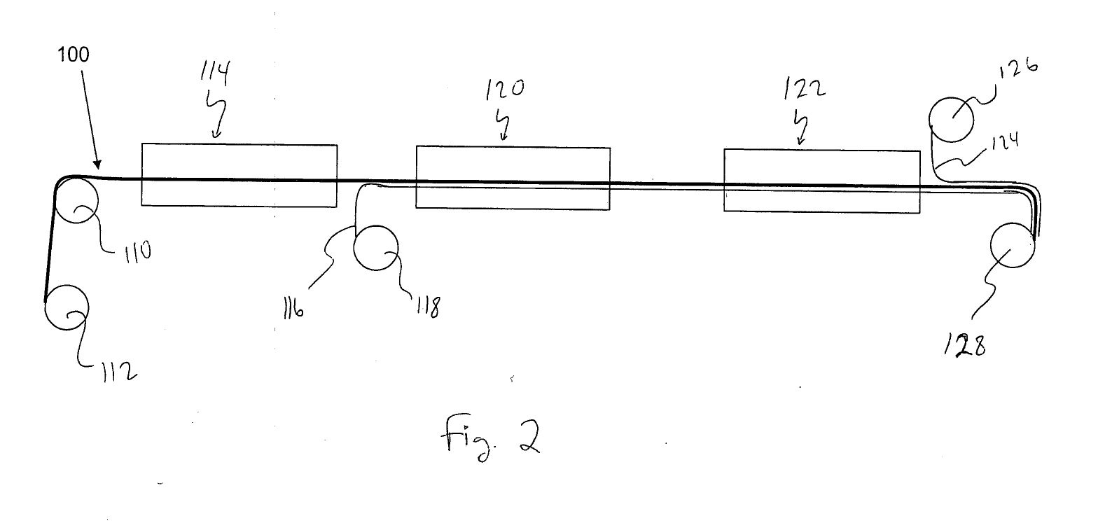

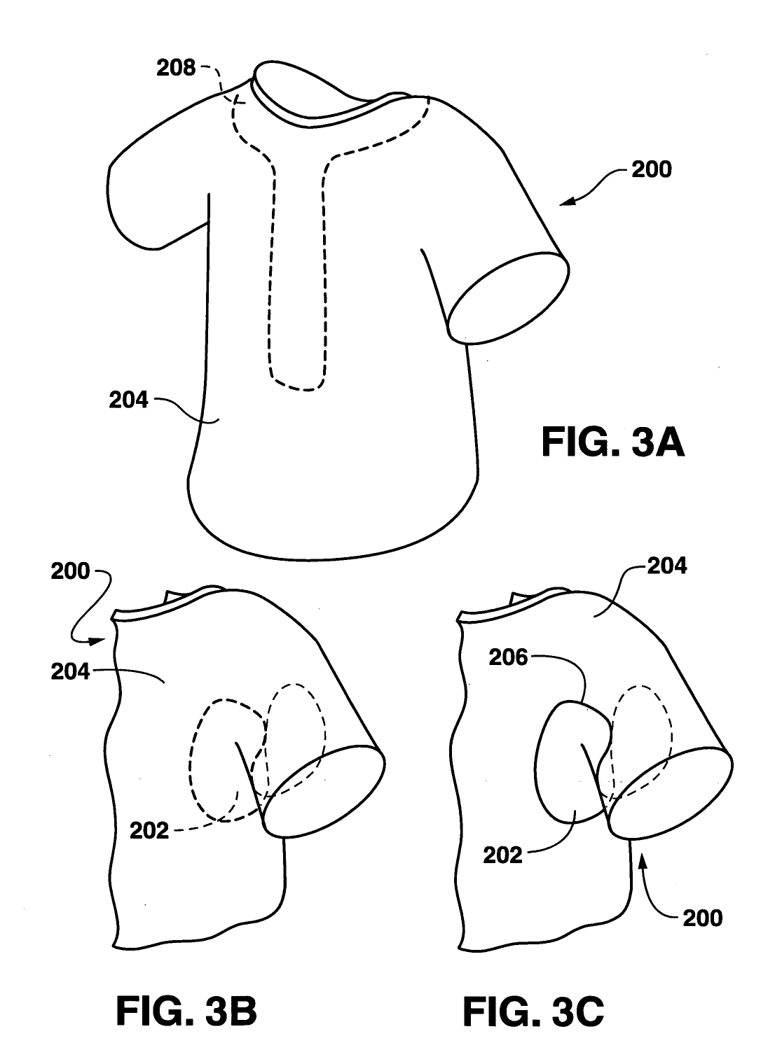

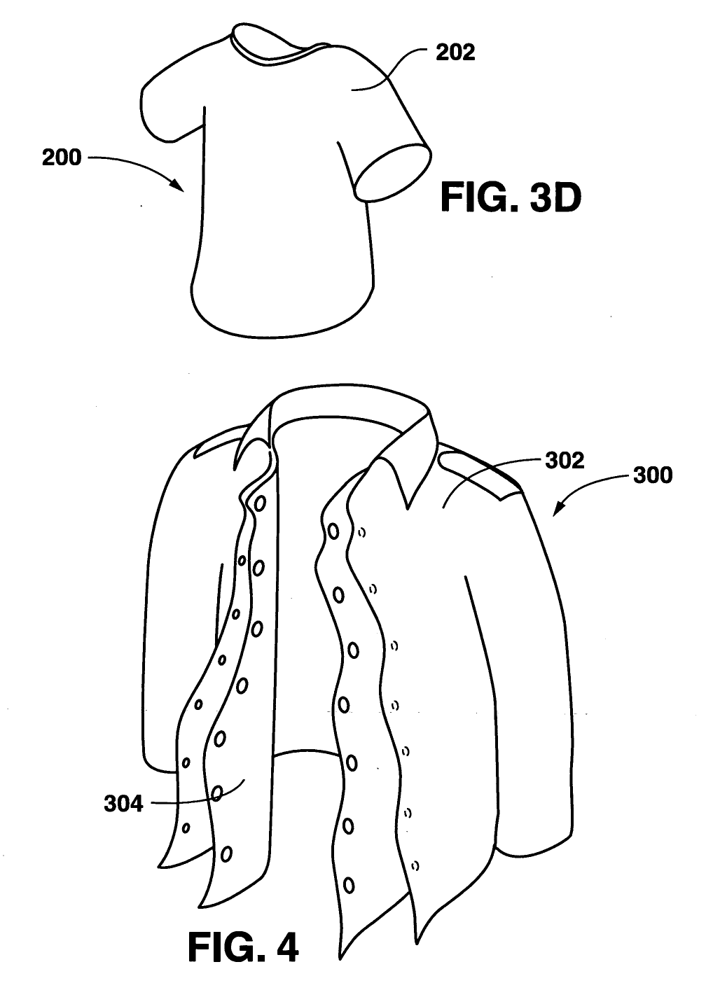

For example, referring to FIGS. 3B and 3C, the T-shirt 200 can be constructed of the hydrogel-fibrous web composite in the underarm area 202, which is prone to be a hot, damp area of the body covered by T-shirt 200. The remaining area 204 of T-shirt 200 can be constructed of the base fibrous web, without any substantial hydrogel present in area 204. The hydrogel-fibrous web composite can be simply a portion of the T-shirt 200 that was saturated with the hydrogel precursor formulation and polymerized, allowing only that portion to contain the hydrogel. Alternatively, the hydrogel-fibrous web composite can be a separate web sewn, or otherwise attached, to the rest of the material, such as shown in FIG. 3C where the hydrogel-fibrous web composite in underarm area 202 is sewn to the remaining base fibrous web area 204 at seam 206. In another embodiment, the hydrogel-fibrous web composite can be present in the neck and chest area 208 of T-shirt 200, as shown if FIG. 3A. In yet another embodiment, the entire T-shirt 200 may be constructed of the hydrogel-fibrous web composite 202, such as shown in FIG. 3D.

In another embodiment, the hydrogel-fibrous web composite can be utilized as part of clothing outfit, especially those that may induce sweating by the wearer. For instance, the hydrogel-fibrous web composite material can be used as part of a jacket 300, such as shown in FIG. 4. Jacket 300 includes outer shell 302 and inner liner 304. According to one embodiment, the inner liner 304 may be constructed of the hydrogel-fibrous web composite material, allowing the inner liner to absorb any moisture produced by the wearer. As such, any moisture produced by the wearer's body can be absorbed by the inner liner, allowing the wearer to stay dry, even if the wearer begins to sweat under the jacket.

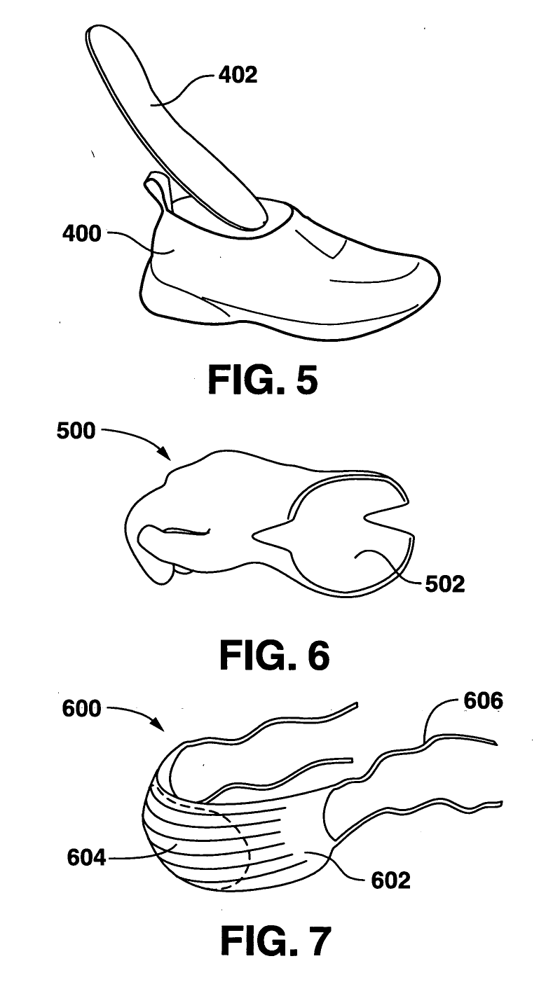

In yet another embodiment, the hydrogel-fibrous web composite can be including as part of a sole insert 402, for use in a shoe 400, such as shown in FIG. 5. As shown, the sole insert 402 is used to add comfort to the wearer of shoe 400. According to this embodiment, the sole insert 402 can also absorb any sweat produced by the wearer, keeping the wearer's feet dryer than otherwise possible. Although a sole insert 402 is shown in FIG. 5, it is to be understood that any shoe insert or shoe liner could be utilized in accordance with the present invention. Also, the hydrogel-fibrous web composite can be utilized in the construction of a sock.

The embodiment shown in FIG. 6 is a glove 500 that includes the hydrogel-fibrous web composite material in at least a portion of the inside surface 502. The hydrogel-fibrous web composite of the inside surface 502 can help keep the wearer's hand dry and comfortable, even if the hand begins to sweat after prolonged use of the glove. For instance, the inside surface 502 can be a woven fabric configured to provide warmth to the hand of the wearer. Thus, if the hand of the wearer sweats during use of the glove 500, then an inside surface can absorb this moisture, while still providing warmth to the hand. In another embodiment, the glove 500 can be a glove configured for use in semiconductor clean rooms, where the glove can control the humidity by absorbing moisture.

FIG. 7 depicts yet another embodiment where the hydrogel-fibrous web composite is included in a facemask 600. The facemask 600 is generally configured to be secured on a user such that area 604 of the mask 602 covers the mouth and nose of the wearer. Straps 606 are used to secure the facemask onto the head of the wearer. The area 604 covering the mouth and nose of the wearer can include the hydrogel-fibrous web composite to absorb water vapor caused by breathing of the wearer. Alternatively, the hydrogel-fibrous web composite can be used on the sides of the face mask to absorb moisture from breathing without significantly affecting the breathability of the mask.

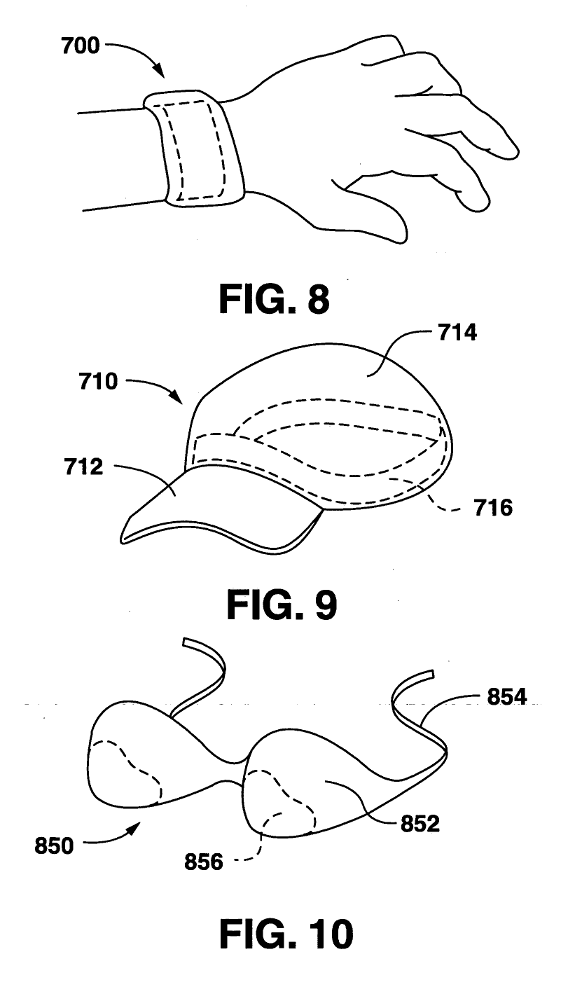

FIGS. 8 and 9 depict a wristband 700 and a hat 710, respectively, each of which can include the composite hydrogel-fibrous web. For instance, the hat 710 can include a visor 712 and a headpiece 714. Then entire fabric of the headpiece 714 can include the composite hydrogel-fibrous web. Alternatively, a portion of the hat 710 can include the composite hydrogel-fibrous web. For instance, the headpiece can include a headband 716 of the hydrogel-fibrous web composite inserted into the headpiece 714.

FIG. 10 shows yet another embodiment of a use of a hydrogel-fibrous web composite in a brassier 850. Brassier 850 can include support cups 852 and straps 854. The support cups 852 can include a composite hydrogel-fibrous web. For instance, the support cups 852 can include an area 856 constructed of a hydrogel-fibrous web composite configured to be located in the center of the support cups 852. This area may not only absorb moisture from sweat but also any moisture produced and inadvertently release by nursing mothers.

### EXAMPLES

### Example 1

The following hydrogel precursor formulations were produced and then a respective web was saturated with the respective solution. Then, each saturated fabric was exposed to UV light using the UV Curing equipment F600S Ultraviolet Lamp System (Fusion US Systems, Inc., Woburn, Mass.), which delivers a dose of about 5.0 J/cm².

TABLE 1

| INGREDIENT | Wt % |
|---|---|
| Water | 16.15 |
| AMPS 2405 | 62.50 |
| MBA (1% soln) | 10.00 |
| Glycerine | 10.00 |
| DMSO | 1.25 |
| I-184 | 0.10 |

Embedded fabric: 0.5 osy polypropylene SMS

TABLE 2

| INGREDIENT | Wt % |
|---|---|
| Water | 0.00 |
| AMPS 2405 | 78.65 |
| MBA (1% soln) | 10.00 |
| Glycerine | 10.00 |
| DMSO | 1.25 |
| I-184 | 0.10 |

Embedded fabric: 0.5 osy polypropylene SMS

TABLE 3

| INGREDIENT | WT % |
|---|---|
| Water | 15.95 |
| AMPS 2405 | 62.50 |
| MBA (1% soln) | 10.00 |
| Glycerine | 10.00 |
| DMSO | 1.25 |
| I-184 | 0.10 |
| Aloe cucumber aloe # 51341 | 0.20 |

Embedded fabric: 0.5 osy polypropylene SMS

The commercial name and/or abbreviations of the ingredients listed above are as follows:

AMPS 2405 is 2-acrylamido-2-methyl propane sulfonic acid, sodium salt (50% active), available from Noveon, Inc. (Cleveland, Ohio);

MBA is Methylene bis-acrylamide, available from Aldrich (Milwaukee, Wis.);

Glycerine is available from Aldrich (Milwaukee, Wis.);

DMSO is dimethyl sulfoxide, available from Aldrich (Milwaukee, Wis.);

I-184 is a photoinitiator available from Ciba Specialty Chemicals, Inc. (Tarrytown, N.Y.) believed to include 1-hydroxycyclohexyl phenyl ketone; and

Aloe cucumber aloe # 51341 is available from Aloecorp, Lacey, Wash.

Each of the formulations shown in tables 1-3 produced hydrogels that were fully integrated with the nonwoven web and which exhibited high fluid absorbency, good adhesion to the web, and good mechanical strength.

### Example 2

The following hydrogel precursor formulation was produced:

TABLE 4

| INGREDIENT | WT % |
|---|---|
| Water | 26.78 |
| AMPS 2405 | 60 |
| MBA (1% soln) | 1 |
| I-184 | 0.10 |
| DMSO | 3.12 |

The following fabrics were then saturated with the hydrogel precursor formulation of Table 4. A surface treatment containing a surfactant was also applied via saturation to the hydrogel-fibrous web composite. Then, each saturated fabric was exposed to UV light using the UV Curing equipment F600S Ultraviolet Lamp System (Fusion US Systems, Inc., Woburn, Mass.), which delivers a dose of about 5.0 J/cm². Control samples 16-20 were also produced without any hydrogel add-on.

TABLE 5

| | | Basis | Hydrogel | |
|---|---|---|---|---|
| | | Weight | add-on (wt | |
| Sample | Type of Web | (gsm) | %) | Surface Treatment |
| 1 | Polypropylene meltblown | 20 | 1373 | 2 wt % Glucopon 220 UP |
| 2 | Polypropylene meltblown | 20 | 1373 | 0.5 wt % Glucopon 220 UP |
| 3 | Hydroentangled | 54 | 2553 | 0.5 wt % Glucopon 220 UP |
| | polypropylene spunbond | | | |
| 4 | Hydroentangled | 54 | 2553 | 0.5 wt % Masil SF-19 |
| | polypropylene spunbond | | | |
| 5 | Polypropylene meltblown | 20 | 1373 | None |
| 6 | Polypropylene bonded | 54 | 1510 | 0.5 wt % Glucopon 220 UP |
| | carded web | | | |
| 7 | Polypropylene bonded | 54 | 1510 | None |
| | carded web | | | |
| 8 | Polypropylene meltblown | 20 | 1373 | 0.5 wt % Masil SF-19 |
| 9 | Polypropylene bonded | 54 | 1510 | 0.5 wt % Glucopon 220 UP |
| | carded web | | | |
| 10 | Hydroentangled | 54 | 2553 | None |
| | polypropylene spunbond | | | |
| 11 | Polypropylene bonded | 74 | 1491 | None |
| | carded web (54 gsm) + Polypropylene | | | |
| | meltblown | | | |
| | (20 gsm) | | | |
| 12 | Polypropylene bonded | 74 | 1491 | 0.5 wt % Glucopon 220 UP |
| | carded web (54 gsm) + Polypropylene | | | |
| | meltblown | | | |
| | (20 gsm) | | | |
| 13 | Polypropylene bonded | 74 | 1491 | 0.5 wt % Masil SF-19 |
| | carded web (54 gsm) + Polypropylene | | | |
| | meltblown | | | |
| | (20 gsm) | | | |
| 14 | Woven cotton Muslin | | 215 | None |
| | Cloth #3 available from | | | |
| | Testfabrics, Inc. (Penn.) | | | |
| 15 | Hydroentangled | 64 | 616 | None |
| | pulp/polypropylene | | | |
| | composite (21% | | | |
| | polypropylene, 79% pulp) | | | |
| 16 | Woven cotton Muslin | | 0 | None |
| | Cloth #3 available from | | | |
| | Testfabrics, Inc. (Penn.) | | | |
| 17 | Hydroentangled | 64 | 0 | None |
| | pulp/polypropylene | | | |
| | composite (21% | | | |
| | polypropylene, 79% pulp) | | | |
| 18 | Polypropylene meltblown | 20 | 0 | None |
| 19 | Hydroentangled | 54 | 0 | None |
| | polypropylene spunbond | | | |
| 20 | Polypropylene bonded | 54 | 0 | None |
| | carded web | | | |

The moisture absorption of each of the samples of Table 5 was then tested. Each sample was put into a chamber and subjected to an atmosphere of 90% relative humidity at 90° F. A temperature and humidity chamber available from Thermotron Industries, Model No. SM-86 was used. The samples were removed from the chamber every 30 minutes and weighed to determine and quantify the amount of moisture absorption. This procedure took place at 30 minute intervals for a total of eight hours. The results of the moisture absorption test are shown in Table 6:

TABLE 6
Hydrogel Moisture Absorption Test

| | | 30 Minutes | | | 60 Minutes | | | 90 Minutes | | | 120 Minutes | | |
|---|---|---|---|---|---|---|---|---|---|---|---|---|---|
| | Initial weight | Increase | Total | | Increase | Total | | Increase | Total | | Increase | Total | |
| Sample | of sample (g) | (g) | wt (g) | % Change | (g) | wt (g) | % Change | (g) | wt (g) | % Change | (g) | wt (g) | % Change |
| 1 | 0.6331 | 0.182 | 0.841 | 27.54% | 0.227 | 0.866 | 36.44% | 0.245 | 0.304 | 37.15% | 0.294 | 0.323 | 40.02% |
| 2 | 0.6018 | 0.100 | 0.702 | 16.69% | 0.133 | 0.7432 | 23.04% | 0.174 | 0.776 | 28.32% | 0.188 | 0.730 | 31.30% |
| 3 | 0.6551 | 0.153 | 0.814 | 24.30% | 0.204 | 0.853 | 31.13% | 0.232 | 0.887 | 35.37% | 0.253 | 0.303 | 38.67% |
| 4 | 0.4742 | 0.115 | 0.530 | 24.34% | 0.144 | 0.6182 | 30.37% | 0.163 | 0.637 | 34.35% | 0.174 | 0.648 | 36.74% |
| 5 | 0.5486 | 0.137 | 0.685 | 24.30% | 0.165 | 0.715 | 30.26% | 0.187 | 0.735 | 38.00% | 0.155 | 0.748 | 36.27% |
| 6 | 0.6123 | 0.081 | 0.693 | 13.21% | 0.120 | 0.732 | 13.55% | 0.164 | 0.777 | 26.85% | 0.179 | 0.791 | 29.23% |
| 7 | 0.3823 | 0.072 | 0.455 | 18.83% | 0.108 | 0.450 | 28.25% | 0.119 | 0.502 | 31.10% | 0.129 | 0.511 | 33.69% |
| 8 | 0.3281 | 0.138 | 0.466 | 42.03% | 0.166 | 0.4338 | 50.50% | 0.175 | 0.508 | 54.68% | 0.189 | 0.517 | 57.54% |
| 9 | 0.5568 | 0.147 | 0.703 | 26.31% | 0.164 | 0.721 | 29.53% | 0.189 | 0.746 | 33.93% | 0.231 | 0.783 | 41.66% |
| 10 | 0.6023 | 0.119 | 0.721 | 19.66% | 0.145 | 0.7476 | 24.00% | 0.137 | 0.800 | 32.63% | 0.209 | 0.812 | 34.57% |
| 11 | 0.8767 | 0.181 | 1.057 | 20.53% | 0.236 | 1.113 | 26.91% | 0.280 | 1.157 | 31.47% | 0.311 | 1.188 | 33.46% |
| 12 | 0.7277 | 0.083 | 0.810 | 11.36% | 0.128 | 0.8552 | 17.52% | 0.171 | 0.833 | 23.47% | 0.186 | 0.314 | 25.65% |
| 13 | 1.0573 | 0.135 | 1.132 | 12.73% | 0.185 | 1.2425 | 17.52% | 0.237 | 1.2345 | 22.43% | 0.291 | 1.349 | 27.56% |
| 14 | | | | 32.00% | | | | | | | | | 44.00% |
| 15 | | | | 40.00% | | | | | | | | | 53.00% |
| 16 | | | | 1.33% | | | | | | | | | 1.18% |
| 17 | | | | 3.57% | | | | | | | | | 3.57% |
| 18 | | | | 0.00% | | | | | | | | | 1.02% |
| 19 | | | | 2.81% | | | | | | | | | 3.37% |
| 20 | | | | 0.00% | | | | | | | | | 0.31% |
| | | 150 Minutes | | | 180 Minutes | | | 210 Minutes | | | 240 Minutes | | |
| | Initial weight | Increase | Total | | Increase | Total | | Increase | Total | | Increase | Total | |
| Sample | of sample (g) | (g) | wt (g) | % Change | (g) | wt (g) | % Change | (g) | wt (g) | % Change | (g) | wt (g) | % Change |
| 1 | 0.6591 | 0.273 | 0.992 | 41.40% | 0.279 | 0.338 | 42.35% | 0.264 | 0.943 | 43.01% | 0.284 | 0.944 | 43.15% |
| 2 | 0.6016 | 0.199 | 0.800 | 33.05% | 0.207 | 0.8083 | 34.36% | 0.210 | 0.012 | 34.97% | 0.213 | 0.814 | 35.37% |
| 3 | 0.6551 | 0.268 | 0.923 | 40.89% | 0.273 | 0.934 | 42.53% | 0.287 | 0.942 | 43.75% | 0.292 | 0.947 | 44.50% |
| 4 | 0.4742 | 0.176 | 0.650 | 37.14% | 0.175 | 0.6492 | 36.50% | 0.178 | 0.6522 | 37.54% | 0.179 | 0.653 | 37.68% |
| 5 | 0.5486 | 0.201 | 0.750 | 36.71% | 0.226 | 0.775 | 41.20% | 0.230 | 0.779 | 41.38% | 0.225 | 0.778 | 41.82% |
| 6 | 0.6123 | 0.186 | 0.738 | 30.36% | 0.135 | 0.0077 | 31.31% | 0.202 | 0.8145 | 32.33% | 0.205 | 0.817 | 33.41% |
| 7 | 0.3823 | 0.132 | 0.514 | 34.45% | 0.136 | 0.518 | 33.60% | 0.138 | 0.520 | 36.02% | 0.140 | 0.522 | 36.59% |
| 8 | 0.3281 | 0.192 | 0.520 | 58.46% | 0.196 | 0.5238 | 53.65% | 0.198 | 0.5265 | 60.41% | 0.199 | 0.527 | 60.65% |
| 9 | 0.5568 | 0.242 | 0.799 | 43.50% | 0.253 | 0.809 | 45.35% | 0.256 | 0.813 | 46.01% | 0.262 | 0.819 | 47.09% |
| 10 | 0.6023 | 0.214 | 0.817 | 35.54% | 0.221 | 0.8235 | 36.53% | 0.224 | 0.8258 | 37.14% | 0.227 | 0.830 | 37.63% |
| 11 | 0.8767 | 0.338 | 1.214 | 38.52% | 0.358 | 1.235 | 40.81% | 0.369 | 1.246 | 42.12% | 0.381 | 1.257 | 43.42% |
| 12 | 0.7277 | 0.204 | 0.332 | 28.07% | 0.217 | 0.3451 | 29.87% | 0.228 | 0.9555 | 31.30% | 0.236 | 0.964 | 32.43% |
| 13 | 1.0573 | 0.317 | 1.374 | 23.35% | 0.337 | 1.3347 | 31.31% | 0.353 | 1.4102 | 33.38% | 0.367 | 1.425 | 34.75% |
| 14 | | | | | | | | | | | | | 37.00% |
| 15 | | | | | | | | | | | | | 46.00% |
| 16 | | | | | | | | | | | | | 1.35% |
| 17 | | | | | | | | | | | | | 3.31% |
| 18 | | | | | | | | | | | | | 0.00% |
| 19 | | | | | | | | | | | | | 1.50% |
| 20 | | | | | | | | | | | | | 1.33% |
| | | 270 Minutes | | | 300 Minutes | | | 330 Minutes | | | 360 Minutes | | |
| | Initial weight | Increase | Total | | Increase | Total | | Increase | Total | | Increase | Total | |
| Sample | of sample (g) | (g) | wt (g) | % Change | (g) | wt (g) | % Change | (g) | wt (g) | % Change | (g) | wt (g) | % Change |
| 1 | 0.6591 | 0.287 | 0.946 | 43.51% | 0.288 | 0.947 | 43.62% | 0.288 | 0.547 | 43.62% | 0.287 | 0.946 | 43.57% |
| 2 | 0.6016 | 0.215 | 0.8166 | 35.74% | 0.214 | 0.8154 | 35.54% | 0.215 | 0.8161 | 35.65% | 0.215 | 0.816 | 35.65% |
| 3 | 0.6551 | 0.296 | 0.951 | 45.15% | 0.297 | 0.332 | 45.28% | 0.298 | 0.354 | 45.55% | 0.295 | 0.354 | 45.58% |
| 4 | 0.4742 | 0.181 | 0.655 | 38.15% | 0.180 | 0.654 | 37.36% | 0.180 | 0.654 | 37.85% | 0.178 | 0.652 | 37.52% |
| 5 | 0.5486 | 0.232 | 0.780 | 42.23% | 0.232 | 0.781 | 42.36% | 0.232 | 0.780 | 42.22% | 0.230 | 0.778 | 41.87% |
| 6 | 0.6123 | 0.206 | 0.821 | 34.00% | 0.210 | 0.822 | 34.20% | 0.212 | 0.824 | 34.56% | 0.210 | 0.823 | 34.35% |
| 7 | 0.3823 | 0.142 | 0.524 | 37.17% | 0.141 | 0.524 | 36.33% | 0.141 | 0.523 | 36.78% | 0.140 | 0.522 | 36.59% |
| 8 | 0.3281 | 0.201 | 0.529 | 61.11% | 0.133 | 0.527 | 60.74% | 0.133 | 0.527 | 60.53% | 0.199 | 0.527 | 60.65% |
| 9 | 0.5568 | 0.266 | 0.823 | 47.77% | 0.266 | 0.823 | 47.81% | 0.267 | 0.824 | 48.02% | 0.267 | 0.824 | 47.59% |
| 10 | 0.6023 | 0.230 | 0.833 | 38.12% | 0.229 | 0.832 | 38.05% | 0.230 | 0.833 | 38.13% | 0.231 | 0.833 | 38.23% |
| 11 | 0.8767 | 0.389 | 1.265 | 44.33% | 0.332 | 1.269 | 44.72% | 0.334 | 1.271 | 44.32% | 0.333 | 1.276 | 45.52% |
| 12 | 0.7277 | 0.243 | 0.370 | 33.32% | 0.244 | 0.372 | 33.54% | 0.247 | 0.975 | 33.34% | 0.251 | 0.973 | 34.51% |
| 13 | 1.0573 | 0.330 | 1.438 | | 0.387 | 1.444 | 36.59% | 0.335 | 1.452 | 37.32% | −0.597 | 0.461 | −56.45% |
| 14 | | | | | | | | | | | | | 34.00% |
| 15 | | | | | | | | | | | | | 45.00% |
| 16 | | | | | | | | | | | | | 2.19% |
| 17 | | | | | | | | | | | | | 4.24% |
| 18 | | | | | | | | | | | | | 0.00% |
| 19 | | | | | | | | | | | | | 3.37% |
| 20 | | | | | | | | | | | | | 0.21% |
| | | 390 Minutes | | | 420 Minutes | | | 450 Minutes | | | 480 Minutes | | |
| | Initial weight | Increase | Total | | Increase | Total | | Increase | Total | | Increase | Total | |
| Sample | of sample (g) | (g) | wt (g) | % Change | (g) | wt (g) | % Change | (g) | wt (g) | % Change | (g) | wt (g) | % Change |
| 1 | 0.6591 | 0.285 | 0.344 | 43.24% | 0.268 | 0.345 | 43.35% | 0.287 | 0.948 | 43.57% | 0.258 | 0.347 | 43.67% |
| 2 | 0.6016 | 0.215 | 0.8150 | 35.47% | 0.214 | 0.8157 | 35.53% | 0.216 | 0.8174 | 35.87% | 0.217 | 0.8183 | 36.02% |
| 3 | 0.6551 | 0.299 | 0.354 | 45.63% | 0.300 | 0.955 | 45.72% | 0.300 | 0.955 | 45.73% | 0.300 | 0.956 | 45.86% |
| 4 | 0.4742 | 0.117 | 0.651 | 37.28% | 0.179 | 0.653 | 37.71% | 0.178 | 0.652 | 37.49% | 0.177 | 0.651 | 37.22% |
| 5 | 0.5486 | 0.229 | 0.776 | 41.76% | 0.231 | 0.779 | 42.03% | 0.231 | 0.780 | 42.13% | 0.233 | 0.782 | 42.45% |
| 6 | 0.6123 | 0.209 | 0.821 | 34.05% | 0.209 | 0.822 | 34.17% | 0.205 | 0.822 | 34.18% | 0.210 | 0.822 | 34.25% |
| 7 | 0.3823 | 0.133 | 0.521 | 38.33% | 0.138 | 0.521 | 36.20% | 0.138 | 0.521 | 36.20% | 0.143 | 0.525 | 37.41% |
| 8 | 0.3281 | 0.198 | 0.526 | 60.38% | 0.183 | 0.527 | 60.50% | 0.198 | 0.526 | 60.25% | 0.203 | 0.531 | 61.61% |
| 9 | 0.5568 | 0.267 | 0.823 | 47.88% | 0.267 | 0.824 | 47.53% | 0.268 | 0.825 | 48.20% | 0.273 | 0.830 | 48.99% |
| 10 | 0.6029 | 0.229 | 0.832 | 38.03% | 0.231 | 0.834 | 38.28% | 0.230 | 0.833 | 38.08% | 0.237 | 0.840 | 39.24% |
| 11 | 0.8767 | 0.399 | 1.276 | 45.55% | 0.402 | 1.278 | 45.81% | 0.402 | 1.273 | 45.87% | 0.409 | 1.285 | 46.60% |
| 12 | 0.7277 | 0.252 | 0.580 | 34.64% | 0.253 | 0.381 | 34.81% | 0.255 | 0.383 | 35.07% | 0.261 | 0.383 | 35.89% |
| 13 | 1.0573 | 0.403 | 1.468 | 38.65% | 0.415 | 1.473 | 33.27% | 0.419 | 1.476 | 39.64% | 0.427 | 1.484 | 40.36% |
| 14 | | | | | | | | | | | | | 28.00% |
| 15 | | | | | | | | | | | | | 47.00% |
| 16 | | | | | | | | | | | | | 3.12% |
| 17 | | | | | | | | | | | | | 4.41% |
| 18 | | | | | | | | | | | | | 0.00% |
| 19 | | | | | | | | | | | | | 1.96% |
| 20 | | | | | | | | | | | | | 0.41% |

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto. Further, it is recognized that many embodiments may be conceived that do not achieve all of the advantages of some embodiments, yet the absence of a particular advantage shall not be construed to necessarily mean that such an embodiment is outside the scope of the present invention. In addition, it should be noted that any given range presented herein is intended to include any and all lesser included ranges. For example, a range from 45-90 would also include 50-90; 45-89, and the like. Thus, the range of 95% to 99.999% also includes, for example, the ranges of 96% to 99.1%; 96.3% to 99.7%, and 99.91% to 99.999%, etc.

1. A method for integrating a hydrogel polymer into a fibrous web, the method comprising:
applying a hydrogel precursor formulation to a fibrous web, wherein the hydrogel precursor formulation comprises a hydrogel monomer and a crosslinker; and
polymerizing the hydrogel monomer to form a hydrogel polymer having a three-dimensional crosslinked structure that is integral to the fibrous web.

2. A method as in claim 1, wherein said hydrogel monomer is selected from the group consisting of N-vinyl pyrrolidone, hydroxyethyl methacrylate, methacrylic acid or its salt, styrene sulfonic acid or its salt, potassium sulfopropyl acrylate, dimethyl acrylamide, dimethyl amino ethyl methacrylate or its quaternary salt derivative, and acrylamido methyl propane sulfonic acid or its salt

3. A method as in claim 1, wherein the hydrogel precursor formulation comprises an initiator.

4. A method as in claim 3, wherein said initiator is a photo-initiator and wherein polymerization of the hydrogel monomer is initiated by UV light.

5. A method as in claim 1, wherein said polymerization is initiated by electron beam or gamma rays.

6. A method as in claim 1, wherein said polymerization is initiated in the presence of a chemical initiator.

7. A method as in claim 1, wherein said crosslinker is selected from the group consisting of methylene-bis-acrylamide, diethylene glycol diacrylate, poly(ethylene glycol) diacrylate, triethylene glycol-bis-methacrylate, ethylene glycol-bis-methacrylate, ethylene glycol-dimethacrylate, bisacrylamide, triethyleneglycol-bis-acrylate, 3,3′-ethylidene-bis(N-vinyl-2-pyrrolidone), trimethylolpropate trimethacrylate, glycerol trimethacrylate, polyethylene glycol dimethacrylate, and polymethacrylate crosslinkers.

8. A method as in claim 1, wherein said hydrogel precursor solution comprises a solublizer.

9. A method as in claim 1, wherein said hydrogel precursor solution comprises a surfactant.

10. A method as in claim 1, comprising
treating at least one surface of the fibrous web having the integrated hydrogel with a surfactant.

11. A method as in claim 1, comprising
drying the fibrous web having the integrated hydrogel to have a water content of less than about 20% by weight.

12. A hydrogel-fibrous web composite comprising
a web of fibers; and
a hydrogel polymer integrated within said fibers of said web, wherein the hydrogel polymer has a three-dimensional crosslinked structure that is intertwined with the fibers of the web.

13. A hydrogel-fibrous web composite as in claim 12, wherein the hydrogel polymer is formed from a hydrogel monomer selected from the group consisting of N-vinyl pyrrolidone, hydroxyethyl methacrylate, methacrylic acid or its salt, styrene sulfonic acid or its salt, potassium sulfopropyl acrylate, dimethyl acrylamide, dimethyl amino ethyl methacrylate or its quaternary salt derivative, and acrylamido methyl propane sulfonic acid or its salt.

14. A hydrogel-fibrous web composite as in claim 12, wherein the hydrogel polymer polymerization has been initiated with a photo-initiator and ultraviolet light.

15. A hydrogel-fibrous web composite as in claim 12, wherein the hydrogel polymer is crosslinked with a crosslinker selected from the group consisting of methylene-bis-acrylamide, diethylene glycol diacrylate, poly(ethylene glycol) diacrylate, triethylene glycol-bis-methacrylate, ethylene glycol-bis-methacrylate, ethylene glycol-dimethacrylate, bisacrylamide, triethyleneglycol-bis-acrylate, 3,3′-ethylidene-bis(N-vinyl-2-pyrrolidone), trimethylolpropate trimethacrylate, glycerol trimethacrylate, polyethylene glycol dimethacrylate, and polymethacrylate crosslinkers.

16. A hydrogel-fibrous web composite as in claim 12 comprising a surfactant.

17. A hydrogel-fibrous web composite as in claim 12, wherein said web of fibers is a nonwoven web.

18. A hydrogel-fibrous web composite as in claim 12, wherein said web of fibers is a woven web.

19. A garment comprising the hydrogel-fibrous web composite of claim 12, wherein the garment is configured to absorb moisture.

20. A garment as in claim 19, wherein said web is a woven web comprising fibers selected from the group consisting of cotton fibers, polyester fibers, wool fibers, nylon fibers, and combinations thereof.

21. A garment as in claim 19, wherein the garment is selected from the group consisting of shirts, pants, gloves, socks, brassieres, hats, wristbands, boxer shorts, and jackets.

22. A packaging material comprising the hydrogel-fibrous web composite of claim 12, wherein the packaging material is configured to reduce the amount of moisture contacting a packaged material.

23. A packaging material as in claim 22, wherein the hydrogel-fibrous web composite is a liner positioned within a bottle.

24. A hydrogel-fibrous web composite of claim 12, wherein the hydrogel-fibrous web composite is configured for moisture control in confined spaces selected from the group consisting of basements, greenhouses, laboratories, bathrooms, and clean rooms.

25. A facemask comprising the hydrogel-fibrous web composite of claim 12.

26. A hydrogel-fibrous web composite as in claim 12, wherein the hydrogel-fibrous web composite has a water content of less than about 20% by weight.
